(19) United States
(12) Patent Application Publication
(10) Pub. No.: US 2026/0159073 A1
(43) Pub. Date: Jun. 11, 2026

(54) CONTROL DEVICE, CONTROL METHOD, AND STORAGE MEDIUM

(71) Applicant: HONDA MOTOR CO., LTD., Tokyo (JP)

(72) Inventors: Tomo FUJIMAKI, Tokyo (JP); Kuniyoshi Tanaka, Tokyo (JP); Yuki Hara, Tokyo (JP)

(73) Assignee: HONDA MOTOR CO., LTD., Tokyo (JP)

(21) Appl. No.: 19/408,406

(22) Filed: Dec. 4, 2025

(30) Foreign Application Priority Data
Dec. 6, 2024 (JP) 2024-213381

(51) Int. Cl. B60W 30/06; B60W 40/02; B60W 50/14

(52) U.S. Cl. CPC B60W 30/06; B60W 40/02; B60W 50/14; B60W 2050/146

(57) ABSTRACT

A control device for a moving object includes: a storage that stores parking information indicating a movement start point of the moving object, a parking section of the moving object, and a movement route of the moving object from the movement start point to the parking section; and processing circuitry configured to acquire external environment information of the moving object, perform position estimation on the moving object based on a feature extracted from the external environment information and map information, perform movement control to move the moving object from the movement start point to the parking section based on a result of the position estimation and the parking information, and issue, according to reliability of the position estimation, a guidance notification to guide a user to perform an operation for improving the reliability of the position estimation.

This application is based upon and claims the benefit of priority from prior Japanese patent application No. 2024-213381, filed on Dec. 6, 2024, the entire contents of which are incorporated herein by reference.

### TECHNICAL FIELD

The present disclosure relates to a control device, a control method, and a storage medium storing a control program.

### BACKGROUND ART

In recent years, efforts have been actively made to provide access to a sustainable transportation system in consideration of vulnerable people among traffic participants. In order to implement the above, research and development on further improving safety and convenience of traffic by research and development related to driving assistance technology have been focused on.

In an autonomous driving system that causes a vehicle to travel autonomously without requiring a driving operation of a user, it has been known that a route taken when a vehicle travels to a target position by a driving operation of a user is stored, and when the vehicle travels toward the same target position or on the same route, the vehicle is caused to travel based on a stored route history. In addition, it is known that route information on a route from a current position to the target position is generated based on information acquired by an in-vehicle sensor to cause the vehicle to travel.

For example, JP2024-097775A describes an automobile that stores in a storage device a point where self-position estimation fails along with a time when the self-position estimation fails and image data of the point, and extracts and registers a point where the self-position estimation fails a plurality of times as a change point candidate where map data is to be corrected.

### SUMMARY OF INVENTION

When movement control is performed on a vehicle based on stored route information, it is desirable to make the vehicle continue to travel without interrupting the movement control even when it becomes difficult to estimate a position of the host vehicle while the movement control is being executed. However, in the case of the automobile in JP2024-097775A, if the self-position estimation fails, movement control is interrupted and the automobile cannot continue to travel. JP2024-097775A does not describe making the automobile continue to travel without interrupting the movement control.

Aspects of the present disclosure relate to providing a control device, a control method, and a storage medium storing a control program that can improve usability of a movement control function.

According to an aspect of the present disclosure, there is provided a control device for a moving object, the control device including:
a storage that stores parking information indicating a movement start point of the moving object, a parking section of the moving object, and a movement route of the moving object from the movement start point to the parking section; and
processing circuitry configured to
   acquire external environment information of the moving object,
      perform position estimation on the moving object based on a feature extracted from the external environment information and map information,
      perform movement control to move the moving object from the movement start point to the parking section based on a result of the position estimation and the parking information, and
      issue, according to reliability of the position estimation, a guidance notification to guide a user to perform an operation for improving the reliability of the position estimation.

According to another aspect of the present disclosure, there is provided a control method of a control device for a moving object, including:
acquiring external environment information of the moving object;
   storing parking information indicating a movement start point of the moving object, a parking section of the moving object, and a movement route of the moving object from the movement start point to the parking section;
   performing position estimation on the moving object based on a feature extracted from the external environment information and map information;
   performing movement control to move the moving object from the movement start point to the parking section based on a result of the position estimation and the parking information; and,
      according to reliability of the position estimation, issuing a guidance notification to guide a user to perform an operation for improving the reliability of the position estimation.

According to another aspect of the present disclosure, there is provided a non-transitory computer-readable storage medium storing a control program of a control device for a moving object, the control program causing a processor of the control device to execute a process including:
acquiring external environment information of the moving object;
storing parking information indicating a movement start point of the moving object, a parking section of the moving object, and a movement route of the moving object from the movement start point to the parking section;
performing position estimation on the moving object based on a feature extracted from the external environment information and map information:
performing movement control to move the moving object from the movement start point to the parking section based on a result of the position estimation and the parking information; and,
according to reliability of the position estimation, issuing a guidance notification to guide a user to perform an operation for improving the reliability of the position estimation.

According to the aspects of the present disclosure, a control device, a control method, and a storage medium storing a control program that can improve usability of a movement control function may be provided. This hence contributes to development of a sustainable transportation system.

### BRIEF DESCRIPTION OF DRAWINGS

Exemplary embodiment(s) of the present invention will be described in detail based on the following figures, wherein:

FIG. 1 is a side view of an example of a vehicle 10 equipped with a control device of the present disclosure;

FIG. 2 is a top view of the vehicle 10 illustrated in FIG. 1;

FIG. 3 is a block diagram illustrating an example of an internal configuration of the vehicle 10 illustrated in FIG. 1;

FIG. 4 is a diagram illustrating an example of parking information for the vehicle 10 in a parking facility;

FIG. 5 is a diagram illustrating an example of a relation between a feature acquisition rate and position estimation feasibility;

FIG. 6 is a diagram illustrating a first example of position estimation information displayed according to the feature acquisition rate;

FIG. 7 is a diagram illustrating a second example of the position estimation information displayed according to the feature acquisition rate;

FIG. 8 is a diagram illustrating a third example of the position estimation information displayed according to the feature acquisition rate;

FIG. 9 is a diagram illustrating a fourth example of the position estimation information displayed according to the feature acquisition rate;

FIG. 10 is a diagram illustrating a fifth example of the position estimation information displayed according to the feature acquisition rate;

FIG. 11 is a flowchart illustrating a first example of position estimation processing;

FIG. 12 is a flowchart illustrating a second example of the position estimation processing;

FIG. 13 is a flowchart illustrating a first example of lost point processing; and

FIG. 14 is a flowchart illustrating a second example of the lost point processing.

### DESCRIPTION OF EMBODIMENTS

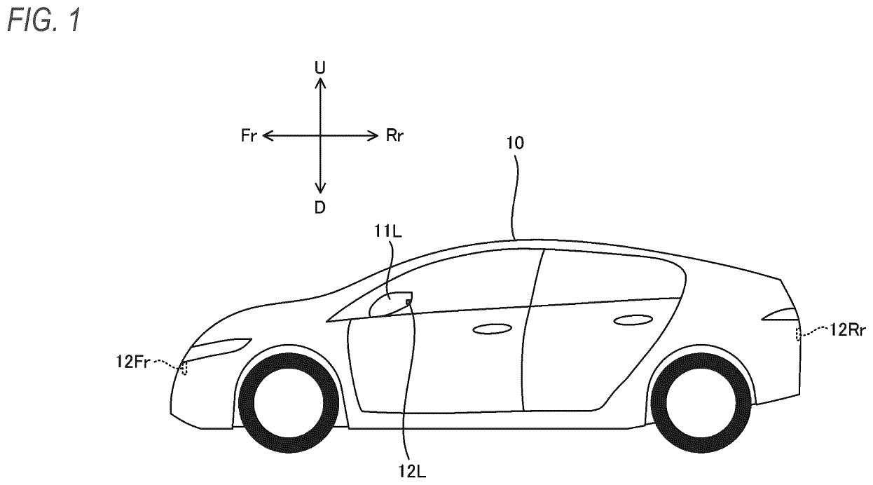

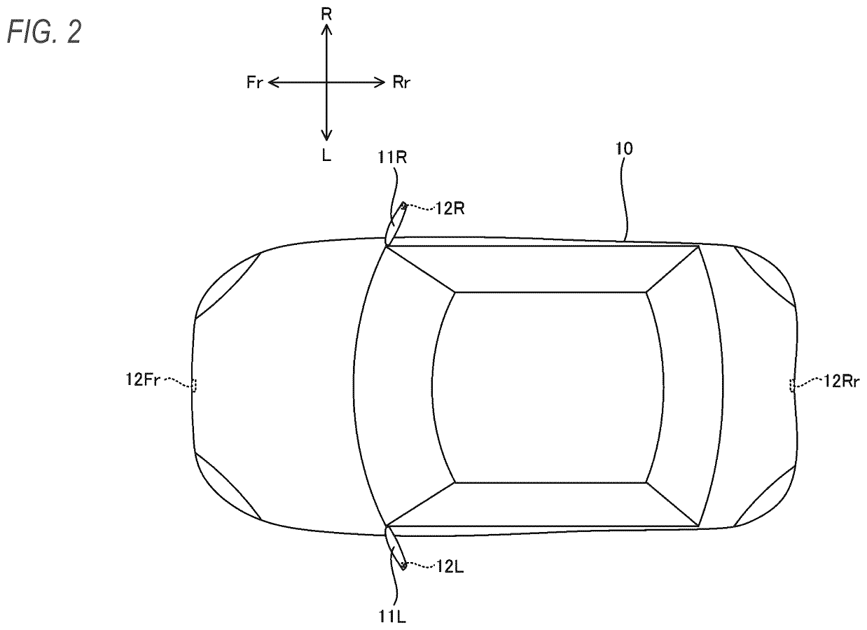

Hereinafter, an embodiment of a control device, a control method, and a storage medium storing a control program of the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 illustrated in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Vehicle 10 Equipped with Control Device

FIG. 1 is a side view of an example of the vehicle 10 equipped with a control device according to the present disclosure. FIG. 2 is a top view of the vehicle 10 illustrated in FIG. 1. The vehicle 10 is an example of a moving body in the present disclosure.

The vehicle 10 is an automobile including a drive source (not illustrated) and wheels including drive wheels driven by power of the drive source and steerable steered wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by pivoting about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

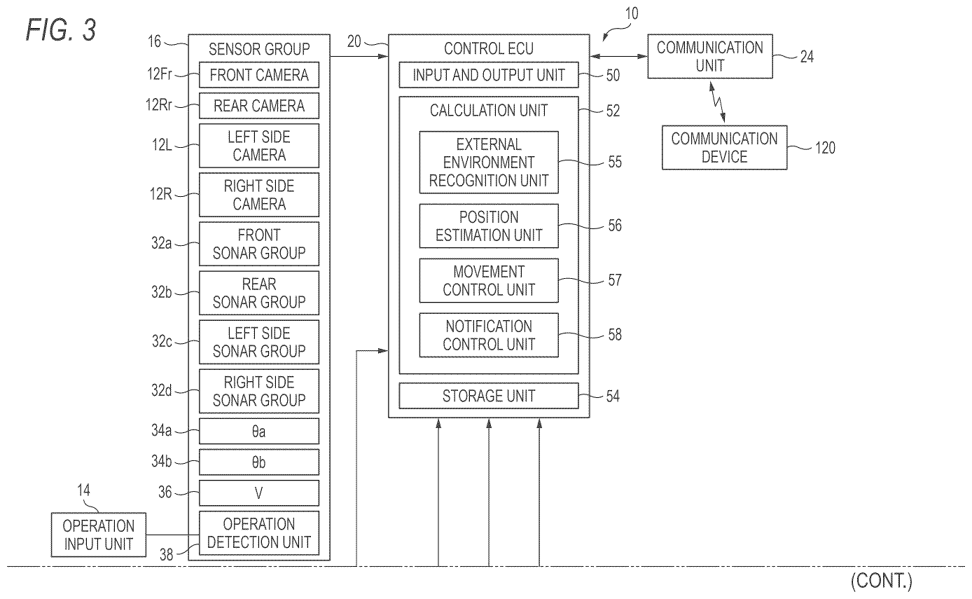

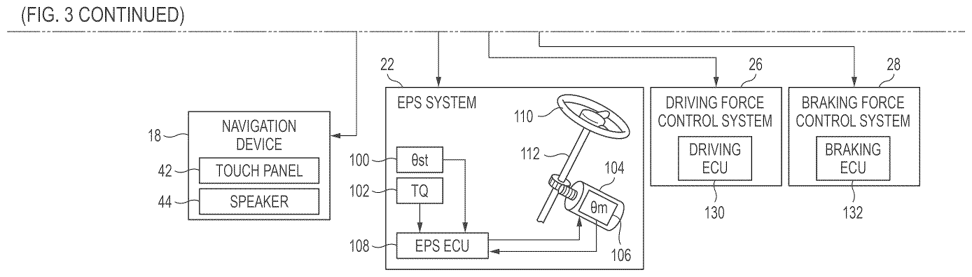

Internal 10 illustrated in FIG. 1. As illustrated in FIG. 3, the vehicle 10 includes a sensor group 16, a navigation device 18, a control electronic control unit (ECU) 20, an electric power steering (EPS) system 22, and a communication unit 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 includes wheel sensors 34a and 34b, a vehicle speed sensor 36, and an operation detection unit 38.

The front camera 12Fr, the rear camera 12Rr, the left side camera 12L, and the right side camera 12R acquire periphery recognition data (for example, peripheral images) for recognizing surroundings of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining the images captured by the cameras is referred to as a top view image of the vehicle 10. Further, an image hat has undergone image processing to three-dimensionally reconstruct a composite image formed from images captured by the cameras is referred to as a three-dimensional image.

The front sonar group 32a, the rear sonar group 32b, the left side sonar group 32c, and the right side sonar group 32d emit sound waves to the periphery of the vehicle 10, and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches the side mirrors 11L and 11R between opened and closed states, a shift lever (a selector lever or a selector), and a light switch for switching ON/OFF state or HIGH/LOW state of headlights.

The navigation device 18 detects a current position (position coordinates) of the vehicle 10 by using, for example, a global positioning system (GPS), and guides the user along a movement route to a destination. The navigation device 18 includes a storage device (not illustrated) including a map information database. The navigation device 18 also includes a touch panel 42 and a speaker 44. The touch panel 42 functions as an input device and a display device of the control ECU 20. The speaker 44 outputs various types of guidance information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes a memory parking button for requesting parking by automatic steering of the control ECU 20, and a parking support button for requesting support while parking the vehicle by an operation of the user. The exiting assistance button includes a memory exiting button for requesting exiting by the automatic steering of the control ECU 20, and an exiting support button for requesting support while exiting by an operation of the user. Note that a constituent element other than the touch panel 42, for example, an information terminal such as a smartphone or a tablet may be used as the input device or the display device.

The “parking”, for example, is a stop as the user gets on and off the vehicle, and excludes a temporary stop due to a traffic signal or the like. Further, the “parking section” means a section indicating a position where the vehicle 10 is to be stopped, that is, a section to be parked.

The control ECU 20 includes an input and output unit 50, a calculation unit 52, and a storage unit 54. The calculation unit 52 is implemented by, for example, processing circuitry or a processor such as a central processing unit (CPU). The calculation unit 52 executes various types of control by controlling units based on a program stored in the storage unit 54. The calculation unit 52 receives and outputs signals from and to each unit connected to the control ECU 20 via the input and output unit 50. The control ECU 20 is an example of a “control device” in the present disclosure.

The storage unit 54 stores information on memory movement (memory parking or exiting) of the vehicle 10. The information on the memory movement is information for autonomous movement or assisted movement of the vehicle 10 based on pre-stored movement information. For example, the storage unit 54 stores parking information indicating a movement start point from which the memory movement starts, a parking section where the vehicle 10 is stopped by the memory movement, and a route from the movement start point to the parking section.

The calculation unit 52 includes an external environment recognition unit 55 that acquires external environment information of the vehicle 10, a position estimation unit 56 that performs position estimation on the vehicle 10, a movement control unit 57 that performs movement control on the vehicle 10, and a notification control unit 58 that provides operation guidance to the user of the vehicle 10.

The external environment recognition unit 55 acquires peripheral images of the vehicle 10 captured by the front camera 12Fr, the rear camera 12Rr, the left side camera 12L, and the right side camera 12R from the cameras. The external environment recognition unit 55 acquires external environment information of the vehicle 10 based on the peripheral images acquired from each camera.

The position estimation unit 56 performs position estimation to estimate a position of the vehicle 10 based on a feature extracted from the external environment information and map information. The “feature extracted from the external environment information” is a characteristic object, for example, included in the external environment information on a movement route along which the vehicle 10 travels. The “map information” is map information including a feature stored in past memory movement, and is map information stored in the storage unit 54.

The movement control unit 57 performs memory parking assistance and memory exiting assistance of the vehicle 10 through automatic steering in which a steering 110 is automatically operated under control of the movement control unit 57. In the memory parking assistance and the memory exiting assistance, an accelerator pedal (not illustrated), a brake pedal (not illustrated), and the operation input unit 14 are automatically operated. The movement control unit 57 performs support parking assistance and support exiting assistance when the user (driver) operates the accelerator pedal, the brake pedal, and the operation input unit 14 to perform manual parking and manual exiting of the vehicle 10. Note that during the memory parking assistance and the memory exiting assistance, the driver may be in a state of being present in the vehicle 10, or may be in a state of getting off the vehicle 10 and being outside (not being present in the vehicle).

For example, the movement control unit 57 performs the movement control to move the vehicle 10 based on a result of the position estimation by the position estimation unit 56 and parking information indicating the movement start point, the parking section, and the movement route stored in the storage unit 54. The movement control includes parking control for performing memory parking on the vehicle 10 in a predetermined parking section (target parking position) from the movement start point, and exiting control for performing memory exiting on the vehicle 10 from the parking section to a predetermined exiting section (target exit position). The movement control unit 57 can execute the parking control and the exiting control based on an instruction signal input via the input and output unit 50. The input instruction signal includes an instruction signal transmitted by wireless communication from an information terminal or the like of the user. The movement control unit 57 outputs information on the parking control and the exiting control to the information terminal or the like via the input and output unit 50.

The movement control unit 57 performs the movement control on the vehicle 10 when reliability of the position estimation by the position estimation unit 56 is equal to or greater than a first predetermined value. The “reliability of the position estimation” refers to a match degree between the feature extracted from the external environment information and the stored feature, and refers to a “feature acquisition rate” at which the feature can be acquired from the external environment information. The first predetermined value is, for example, a feature acquisition rate of 30%.

When the reliability of the position estimation is less than the first predetermined value, the movement control unit 57 stores in the storage unit 54 a point where the vehicle 10 is positioned when the reliability is less than the first predetermined value, in association with an user operation performed by the user at that point when the reliability of the position estimation changes from being less than the first predetermined value to being equal to or greater than the first predetermined value. The “point where the vehicle is positioned” may be rough position coordinates. In the following description, the point where the vehicle 10 is positioned when the reliability is less than the first predetermined value is also referred to as a “lost point”. The lost point is a point where the reliability of position estimation is low and a self-position cannot be estimated. The “user operation” includes, for example, a speed change for changing a speed of the vehicle 10, a travel trajectory change for changing a trajectory along which the vehicle 10 travels, and a high beam switch for switching headlights of the vehicle 10 to high beams. Note that the user operation is not limited to the operation that has been previously guided to the user by the guidance notification. That is, in a case where the user performs an operation guided by the guidance notification but the operation does not improve the reliability of the position estimation, and then the user performs another operation and the reliability is improved, the other operation performed by the user is stored as a user operation. A user operation performed when the reliability of the position estimation changes from being less than the first predetermined value to being equal to or greater than the first predetermined value will hereinafter also be referred to as a “recovery operation”.

When the vehicle 10 arrives at again the point (lost point) where the reliability of the position estimation is less than the first predetermined value and is stored in the storage unit 54, the movement control unit 57 executes control corresponding to the user operation associated with that point. The “control corresponding to the user operation” refers to control that leads to the same result as the operation performed by the user (for example, the speed change, the travel trajectory change, the high beam switch for the headlights, and the like), but is performed by the movement control unit 57 rather than by the user. Note that the movement control unit 57 may propose (suggest) to the user before performing the control, and may execute the control upon receiving an execution instruction from the user.

The notification control unit 58 issues a guidance notification that guides the user to perform an operation for improving the reliability of the position estimation, according to the reliability. The “operation for improving the reliability” includes, for example, an operation to slow down the movement speed of the vehicle 10, an operation to turn on the headlights at night or an operation to switch the headlights between Hi and Low, and an operation to cause the vehicle 10 to travel so as to approach the feature. For example, an operation to reduce a movement speed when the vehicle 10 is in memory parking is an operation that the user steps on a brake. However, in this case, the steering is controlled by the movement control unit 57.

The “guidance notification” is a notification displayed on a screen or a notification by voice. For example, in a case where the vehicle 10 is capable of memory parking, but the reliability of the position estimation is low, the guidance notification will be a notification such as “Reliability of host vehicle position is low. Please . . . . ” In a case where the vehicle 10 is not capable of memory parking, and the reliability of the position estimation is so low that self-position estimation is impossible, the guidance notification will be a notification such as “Host vehicle position cannot be determined/Autonomous parking is not possible. Please . . . . ”

When the reliability of the position estimation is less than a second predetermined value that is higher than the first predetermined value, the notification control unit 58 issues a guidance notification for improving the reliability. The second predetermined value is, for example, a feature acquisition rate of 70%. The notification control unit 58 issues different guidance notifications when the reliability of the position estimation is less than the first predetermined value and when the reliability is equal to or greater than the first predetermined value and less than the second predetermined value.

The notification control unit 58 displays a peripheral image of the vehicle 10 based on the external environment information, and performs attention display on a partial area of the peripheral image according to the reliability of the position estimation. The “partial area” refers to an area in the peripheral image from which a feature can be extracted if a current estimated position is correct. The area from which the feature can be extracted is an area determined based on a position of the feature stored in the storage unit 54 along with the movement start point, the parking section, and the movement route. The partial area may be an area from which the feature cannot be extracted even though the feature should be extractable in this area. The “attention display” is a type of display that highlights a partial area to draw attention of the user to that partial area, such as surrounding the partial area with a frame or pointing at the partial area with an arrow icon or the like. The notification control unit 58 performs the attention display when the reliability of the position estimation is less than a predetermined value (for example, the second predetermined value).

The notification control unit 58 changes a mode of the attention display according to the reliability of the position estimation. For example, the notification control unit 58 displays a yellow frame in the partial area when the reliability is equal to or greater than the first predetermined value and less than the second predetermined value, and displays a red frame in the partial area when the reliability is less than the first predetermined value. The notification control unit 58 may perform the attention display by finely controlling shading according to the reliability of the position estimation. The notification control unit 58 may display the extracted feature with a mark such as (+), and may change a color of the mark. Furthermore, the notification control unit 58 may not perform attention display on an area where the feature can be extracted (for example, an area where a mark (+) is displayed), so as to draw attention of the user only to the area where the feature cannot be extracted.

When the vehicle 10 arrives again at the point (lost point) stored in the storage unit 54 where the reliability of the position estimation is less than the first predetermined value, the notification control unit 58 issues a guidance notification that guides the user to perform the user operation stored in association with that point. The associated and stored user operation includes, for example, an operation to slow down the movement speed of the vehicle 10, an operation to turn on the headlights at night or an operation to switch the headlights between Hi and Low, an operation to cause the vehicle 10 to travel so as to approach the feature, and an operation other than the operation that the user has been guided to perform in the past by the guidance notification.

An EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for the user's operation on the steering 110 and automatic steering during the parking assistance. The resolver 106 detects a rotation angle θm of the EPS motor 104. The EPS ECU 108 controls the entire EPS system 22. The EPS ECU 108 includes an input and output unit (not illustrated), a calculation unit (not illustrated), and a storage unit (not illustrated).

The communication unit 24 enables wireless communication with another communication device 120. Another communication device 120 includes a base station, a communication device of another vehicle, an information terminal such as a smartphone or a tablet carried by the user of the vehicle 10, and the like. For example, the communication unit 24 includes an ultra wide band (UWB, registered trademark) interface or the like that can execute UWB communication with the information terminal. The communication unit 24 can transmit and receive information on memory parking and exiting and assisted parking and exiting of the vehicle 10 to and from an information terminal or the like.

The driving force control system 26 includes a driving ECU 130. The driving force control system 26 executes driving force control of the vehicle 10. The driving ECU 130 controls a driving force of the vehicle 10 by controlling an engine or the like (not illustrated) based on an operation performed by the user on the accelerator pedal (not illustrated).

The braking force control system 28 includes a braking ECU 132. The braking force control system 28 executes braking force control of the vehicle 10. The braking ECU 132 controls a braking force of the vehicle 10 by controlling a braking mechanism or the like (not illustrated) based on an operation performed by the user on the brake pedal (not illustrated).

### Parking Information in Parking Facility

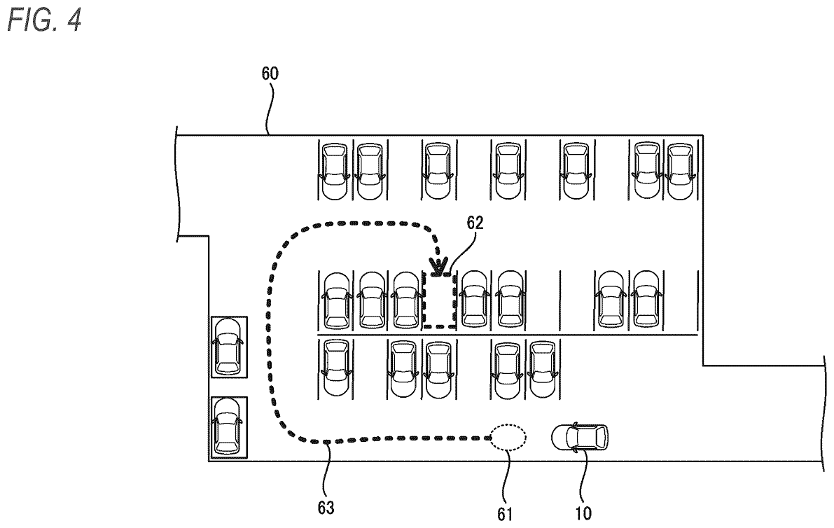

FIG. 4 is a diagram illustrating an example of parking information for the vehicle 10 in a parking facility. A parking facility 60 illustrated in FIG. 4 is a parking facility frequently used by the user of the vehicle 10, and is, for example, a parking facility at a shopping mall. The user of the vehicle 10 frequently uses a parking section 62 among the plurality of parking sections in the parking facility 60 as a place to park the vehicle 10, and registers the parking section 62 in the storage unit 54 as a parking section in which the memory parking can be performed. As illustrated in FIG. 4, the parking section 62 is registered in the storage unit 54 as parking information for executing the memory parking together with a movement start point 61 at which the movement of the vehicle 10 is started when executing the memory parking and a movement route 63 (dashed arrow) along which the vehicle 10 travels from the movement start point 61 to the parking section 62.

To register the parking information, first, the user manually drives the vehicle 10 to travel and stops the vehicle 10 at any movement start point (for example, the movement start point 61). Next, the user presses, for example, a “start parking information registration” button (not illustrated) for starting the registration of the parking information, and then starts the registration. The user manually drives the vehicle 10 to travel along any route (for example, the movement route 63) and parks the vehicle 10 in any parking section (for example, the parking section 62). Next, the user presses, for example, an “end parking information registration” button (not illustrated) for ending the registration of the parking information, and then ends the registration. Note that the movement route 63 shown in the present embodiment is displayed in a simplified manner, but may include a route that requires a quick turn, for example, when backing the vehicle 10 into the parking section 62. Although not illustrated in FIG. 4, the parking information also includes features acquired from the external environment information when the vehicle 10 travels along the movement route 63.

### Relation Between Feature Acquisition Rate and Position Estimation Feasibility

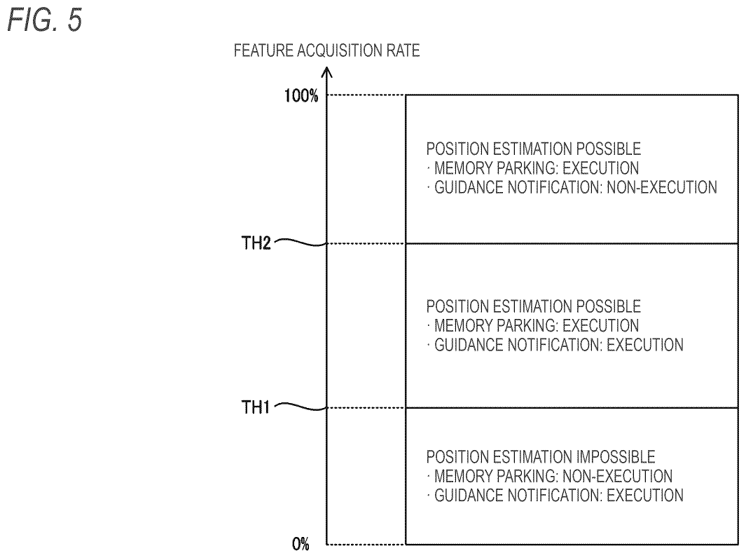

FIG. 5 is a diagram illustrating an example of a relation between the feature acquisition rate and position estimation feasibility. As illustrated in FIG. 5, when the feature acquisition rate (reliability of position estimation) is 0[%] to TH1[%], the vehicle 10 is determined to be in a “position estimation impossible” state, in which the position of the vehicle 10 cannot be estimated based on the feature extracted from the external environment information. TH1 is an example of the “first predetermined value” in the present disclosure. TH1[%] is, for example, 30%. In a case where the position estimation is impossible, the vehicle 10 does not execute the memory parking from the movement start point 61 to the parking section 62 (memory parking: non-execution). In the case where the position estimation is impossible, the vehicle 10 issues a guidance notification that guides the user to perform an operation for improving the feature acquisition rate (guidance notification: execution).

When the feature acquisition rate is between TH1[%] and TH2[%], the vehicle 10 is determined to be in a first state of “position estimation possible”, in which the position of the vehicle 10 can be estimated based on the feature extracted from external environment information. TH2 is an example of the “second predetermined value” in the present disclosure. TH2[%] is, for example, 70%. In the first state in which the position estimation is possible, the vehicle 10 executes the memory parking from the movement start point 61 to the parking section 62 (memory parking: execution). In the first state in which the position estimation is possible, the vehicle 10 issues a guidance notification that guides the user to perform an operation for improving the feature acquisition rate (guidance notification: execution).

When the feature acquisition rate is between TH2[%] and 100[%], the vehicle 10 is determined to be in a second state of “position estimation possible”, in which the position of the vehicle 10 can be estimated based on the feature extracted from external environment information. In the second state in which the position estimation is possible, the vehicle 10 executes the memory parking from the movement start point 61 to the parking section 62 (memory parking: execution). In the second state in which the position estimation is possible, the vehicle 10 does not issue a guidance notification that guides the user to perform the operation for improving the feature acquisition rate (guidance notification: non-execution).

### Position Estimation Information

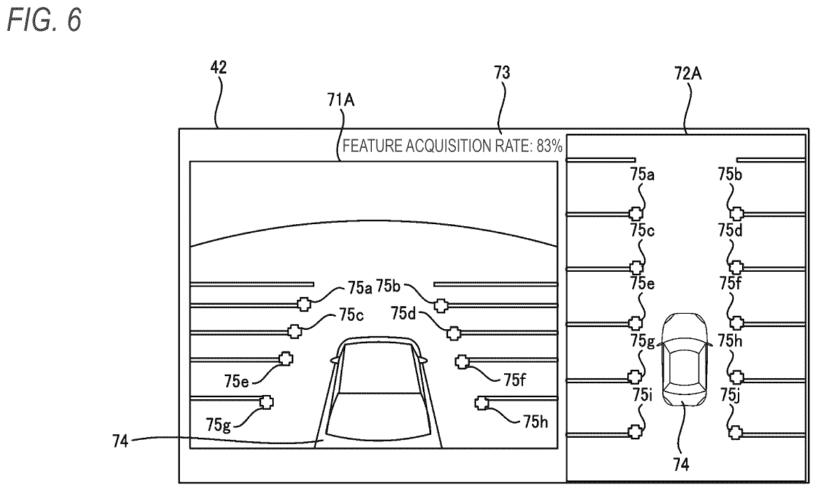

FIG. 6 is a diagram illustrating a first example of position estimation information displayed according to the feature acquisition rate. As illustrated in FIG. 6, the position estimation information of the first example is position estimation information when the “feature acquisition rate” indicating the reliability of position estimation is 83%. The position estimation information is displayed, for example, on the touch panel 42 of the navigation device 18.

The position estimation information of the first example includes a three-dimensional image 71A showing the peripheral image of the vehicle 10, a top view image 72A, and a reliability indicator 73 showing the feature acquisition rate. In the three-dimensional image 71A, a host vehicle image 74 showing an image of the vehicle 10 in traveling, and features 75a to 75h that can be extracted from the peripheral image captured by the current vehicle 10, are displayed. Similarly, in the top view image 72A, the host vehicle image 74 and features 75a to 75j are displayed.

The features 75a to 75j indicate positions of ends of white lines that define parking positions in a parking facility, and are displayed, for example, by marks (+). The features 75a to 75j are features that can be extracted under the current situation of the vehicle 10 among the features in the parking information stored in advance in the storage unit 54. The feature acquisition rate of 83% is a value indicating a ratio of the number of the features 75 a to 75 j to the number of features in the stored parking information.

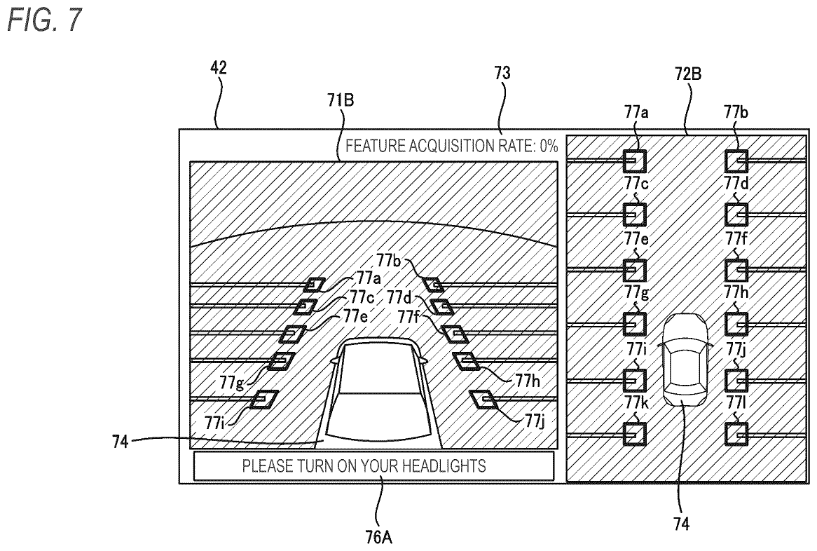

FIG. 7 is a diagram illustrating a second example of the position estimation information displayed according to the feature acquisition rate. As illustrated in FIG. 7, the position estimation information of the second example is position estimation information when the “feature acquisition rate” indicating the reliability of position estimation is 0%.

The position estimation information of the second example includes a three-dimensional image 71B, a top view image 72B, the reliability indicator 73, and a guidance notification image 76A that notifies the user of operation guidance. In the three-dimensional image 71B, the host vehicle image 74 and attention display images 77a to 77j that show a partial area of the peripheral image captured by the current vehicle 10 are displayed. Similarly, in the top view image 72B, the host vehicle image 74 and attention display images 77a to 77l are displayed.

The attention display images 77a to 77l are images showing areas from which features can be extracted if the current estimated position of the vehicle 10 is correct, and are displayed, for example, as “square frames”. Display positions of the attention display images 77a to 77l are determined so as to correspond to the positions of the features indicated by the parking information stored in the storage unit 54. The positions of the features indicated by the parking information stored in the storage unit 54 are positions of ends of white lines that define the parking positions. The feature acquisition rate of 0% is a value indicating a ratio of the number of detected features to the number of features indicated by the stored parking information. That is, a feature acquisition rate of 0% indicates that no features can be detected under the current situation of the vehicle 10.

The guidance notification image 76A is an image that guides a user operation for improving the reliability of the position estimation (feature acquisition rate). In the guidance notification image 76A in the present example, a content that “Please turn on your headlights” for brightening the area around the vehicle 10 is displayed. However, the content of the guidance notification image 76A is not limited thereto, and may be displayed as, for example, “Host vehicle position cannot be determined/Memory parking is impossible. Please turn on headlights”. Note that since the host vehicle image 74 is a created fixed image, display brightness thereof does not change (the image does not become dark) even if the peripheral image becomes dark.

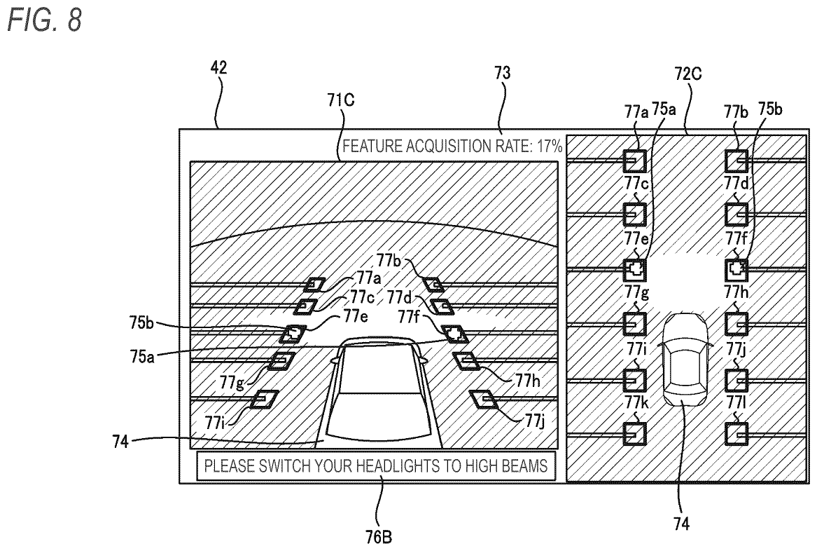

FIG. 8 is a diagram illustrating a third example of the position estimation information displayed according to the feature acquisition rate. As illustrated in FIG. 8, the position estimation information of the third example is position estimation information when the “feature acquisition rate” indicating the reliability of position estimation is 17%.

The position estimation information of the third example includes a three-dimensional image 71C, a top view image 72C, the reliability indicator 73, and a guidance notification image 76B. In the three-dimensional image 71C, the host vehicle image 74, features 75a and 75b, and the attention display images 77a to 77j are displayed. In the top view image 72C, the host vehicle image 74, the features 75a and 75b, and attention display images 77a to 77l are displayed.

The feature acquisition rate of 17% is a value indicating a ratio of the number of detected features to the number of features indicated by the stored parking information, and indicates that 17% of the features can be detected under the current situation of the vehicle 10.

The guidance notification image 76B is an image that guides a user operation for improving the reliability of the position estimation (feature acquisition rate). If the feature acquisition rate is low even when the headlights are turned on, a switch to high beams or the like is guided. In the guidance notification image 76B in the present example, a content that “Please switch your headlights to high beams” for further brightening the area around the vehicle 10 is displayed. However, the content of the guidance notification image 76B is not limited thereto, and may be displayed as, for example, “Reliability of host vehicle position is low. Please switch your headlights to high beams”.

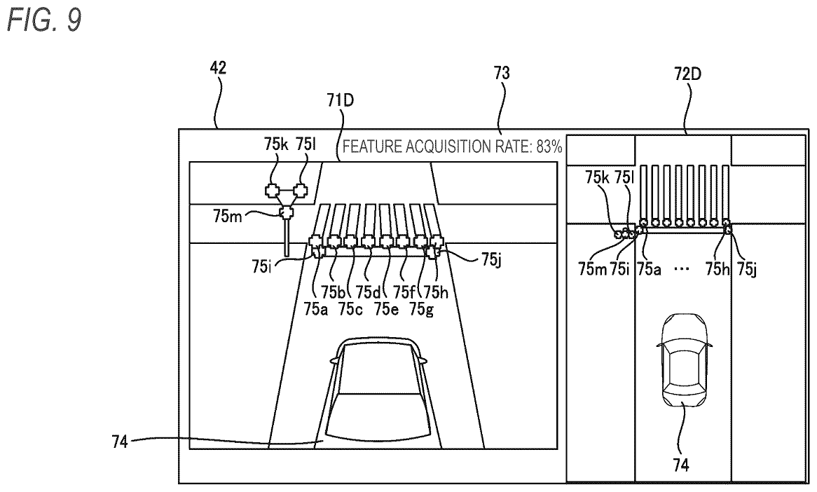

FIG. 9 is a diagram illustrating a fourth example of the position estimation information displayed according to the feature acquisition rate. As illustrated in FIG. 9, the position estimation information of the fourth example is position estimation information when the “feature acquisition rate” indicating the reliability of position estimation is 83%.

The position estimation information of the fourth example includes a three-dimensional image 71D, a top view image 72D, and the reliability indicator 73. In the three-dimensional image 71D and the top view image 72D, the host vehicle image 74 and features 75a to 75m are displayed.

The features 75a to 75h indicate positions of ends of white lines of a pedestrian crossing in the parking facility, and are displayed by, for example, marks (+). The features 75i and 75j indicate positions of ends of a stop line and are similarly displayed by marks (+). The features 75k to 75m indicate positions of stop signs and are similarly displayed by marks (+).

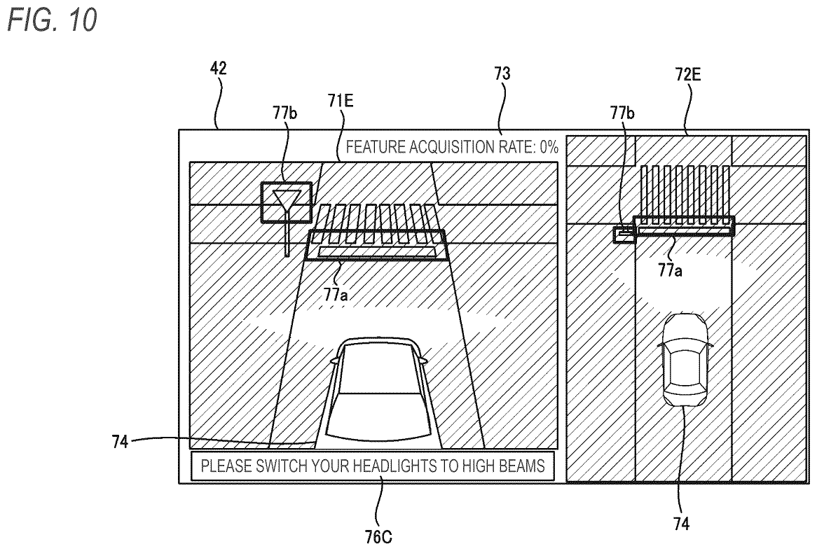

FIG. 10 is a diagram illustrating a fifth example of the position estimation information displayed according to the feature acquisition rate. As illustrated in FIG. 10, the position estimation information of the fifth example is position estimation information when the “feature acquisition rate” indicating the reliability of position estimation is 0%.

The position estimation information of the fifth example includes a three-dimensional image 71E, a top view image 72E, the reliability indicator 73, and a guidance notification image 76C. In the three-dimensional image 71E and the top view image 72E, the host vehicle image 74 and attention display images 77a and 77b are displayed.

The attention display images 77a and 77b are images showing areas from which features can be extracted if the current estimated position is correct, and are displayed, for example, as “square frames”. Display positions of the attention display images 77a and 77b are determined so as to correspond to the positions of the features indicated by the parking information stored in the storage unit 54. The positions of the features indicated by the parking information stored in the storage unit 54 are positions of ends of white lines of a pedestrian crossing, positions of ends of a stop line, and positions of stop signs. The feature acquisition rate of 0% is a value indicating a ratio of the number of detected features to the number of features indicated by the stored parking information, and indicates that no features can be detected under the current situation of the vehicle 10.

The guidance notification image 76C is an image that guides a user operation for improving the reliability of the position estimation (feature acquisition rate). In the guidance notification image 76C in the present example, a content that “Please switch your headlights to high beams” for further brightening the area around the vehicle 10 is displayed. However, the content of the guidance notification image 76C is not limited thereto, and may be displayed as, for example, “Host vehicle position cannot be determined/Memory parking is impossible. Please switch your headlights to high beams”. Note that in the present example, the headlights of the vehicle 10 are in an on state, and therefore the user is guided to switch the headlights to high beams. However, if the headlights of the vehicle 10 are in an off state, the user may be guided to turn on the headlights, or may be guided to turn on the headlights and switch to high beams.

### Position Estimation Processing

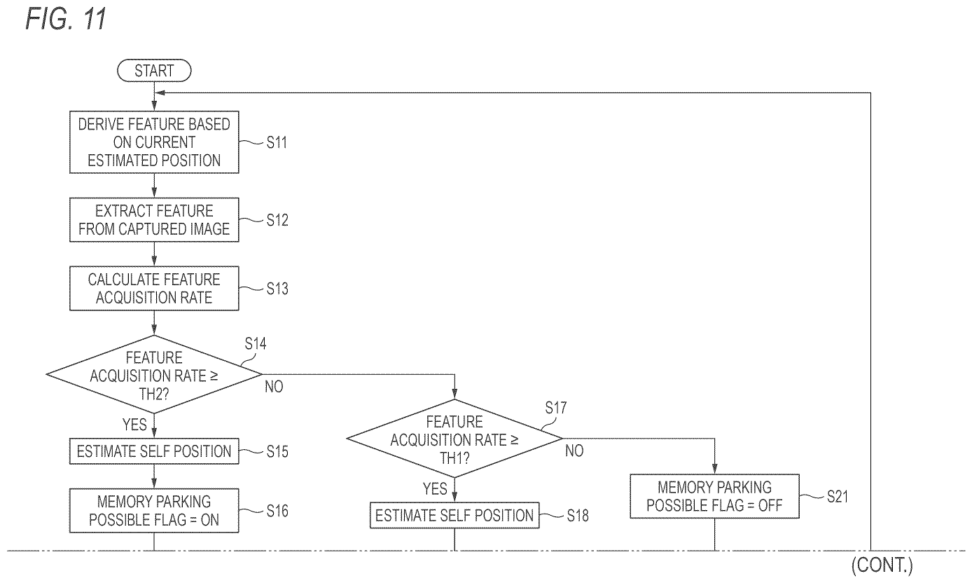

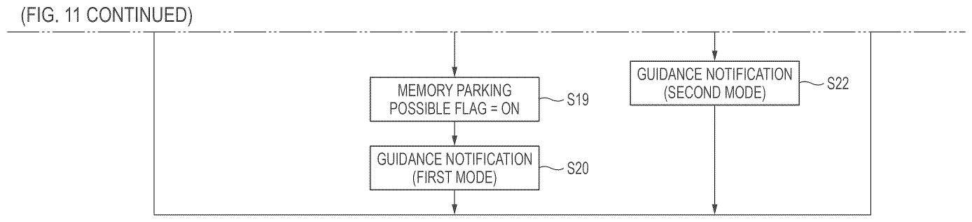

FIG. 11 is a flowchart illustrating a first example of the position estimation processing. The position estimation processing is started when a memory parking button that activates a memory parking function is pressed.

First, the vehicle 10 derives a feature based on a current estimated position of the vehicle 10 (step S11). If the position estimation processing is performed for the second time around and the position of the vehicle 10 has been estimated, the estimated position is used as the “current estimated position of the vehicle 10”. If the position of the vehicle 10 has not been estimated, the current estimated position of the vehicle 10 is acquired by other ways (for example, GPS and the like). Based on map information including features recorded in past memory parking, the vehicle 10 calculates an attention display area, where if the current position of the vehicle 10 is this position, there should be features in this area (for example, attention display images 77a to 77l illustrated in FIG. 7) within the peripheral image (captured image) of the vehicle 10 captured by the cameras or the like.

The vehicle 10 extracts features from the current image captured by the vehicle 10 using the cameras or the like, based on the area of the features derived in step S11 (step S12). The vehicle 10 calculates a feature acquisition rate based on the features extracted in step S13 and the features of the parking information stored in the storage unit 54 (step S13).

Next, the vehicle 10 determines whether the feature acquisition rate calculated in step S13 is equal to or greater than TH2 (for example, 70%) (step S14).

If it is determined in step S14 that the feature acquisition rate is equal to or greater than TH2 (step S14: Yes), the vehicle 10 estimates a position of the vehicle 10 based on the features extracted in step S12 and the map information (step S15). Then, the vehicle 10 sets a memory parking possible flag to ON, which indicates that the current situation is one in which memory parking can be executed (step S16), and returns to step S11.

On the other hand, if it is determined in step S14 that the feature acquisition rate is less than TH2 (step S14: No), the vehicle 10 determines whether the feature acquisition rate calculated in step S13 is equal to or greater than TH1 (for example, 30%) (step S17).

If it is determined in step S17 that the feature acquisition rate is equal to or greater than TH1 (step S17: Yes), the vehicle 10 estimates a position of the vehicle 10 based on the features extracted in step S12 and the map information (step S18). Then, the vehicle 10 sets the memory parking possible flag to ON, which indicates that the current situation is one in which the memory parking can be executed (step S19).

Next, the vehicle 10 issues a guidance notification in a first mode that guides the user to perform an operation for improving reliability of the estimated position (step S20), and then returns to step S11. The guidance notification in the first mode is, for example, a notification such as “Reliability of host vehicle position is low. Please . . . . ”

On the other hand, if it is determined in step S17 that the feature acquisition rate is less than TH1 (step S17: No), the vehicle 10 sets the memory parking possible flag to OFF, which indicates that the current situation is one in which the memory parking cannot be executed (step S21).

Next, the vehicle 10 issues a guidance notification in a second mode that guides the user to perform an operation for improving reliability of the estimated position (step S22), and then returns to step S11. The guidance notification in the second mode is, for example, a notification such as “Host vehicle position cannot be determined/Autonomous parking is not possible. Please . . . . ”

Note that even when the memory parking possible flag is set to ON in the present processing, the vehicle 10 separately determines whether to execute the memory parking. On the other hand, if the memory parking possible flag is set to OFF, the vehicle 10 does not execute the memory parking (interrupts the memory parking in a case where the memory parking is being executed).

As described above, the control device of the present embodiment performs position estimation to estimate the position of the vehicle 10 based on the feature extracted from the external environment information and the map information, and issues a guidance notification that guides the user to perform an operation for improving the reliability of the position estimation according to the reliability. With this configuration, a guidance notification appropriate for the reliability of the position estimation can be provided according to the reliability, and the user can be guided to execute a predetermined operation corresponding to the guidance notification. Accordingly, the reliability of the position estimation can be improved, and it is possible to smoothly perform the memory parking on the vehicle 10. In this way, usability of the memory parking function of the vehicle 10 can be improved.

The control device performs memory parking on the vehicle 10 when the reliability of the position estimation is equal to or greater than the first predetermined value, and issues a guidance notification when the reliability is less than the second predetermined value that is higher than the first predetermined value. With this configuration, the guidance notification is issued not only when the reliability of the position estimation is less than the first predetermined value and the vehicle 10 is not subjected to the memory parking, but also when the reliability is equal to or greater than the first predetermined value and less than the second predetermined value and the vehicle 10 is subjected to the memory parking, so that the guidance notification appropriate for each level of reliability can be issued. Accordingly, the usability of the memory parking function of the vehicle 10 can be improved.

The control device performs attention display on the partial area of the peripheral image of the vehicle 10 displayed on the touch panel 42 from which features can be extracted, according to the reliability of the position estimation. With this configuration, the user can see the attention display together with the guidance notification, and therefore it is possible to increase a rate at which the user performs an operation in response to the guidance notification. In this way, the usability of the memory parking function of the vehicle 10 can be improved.

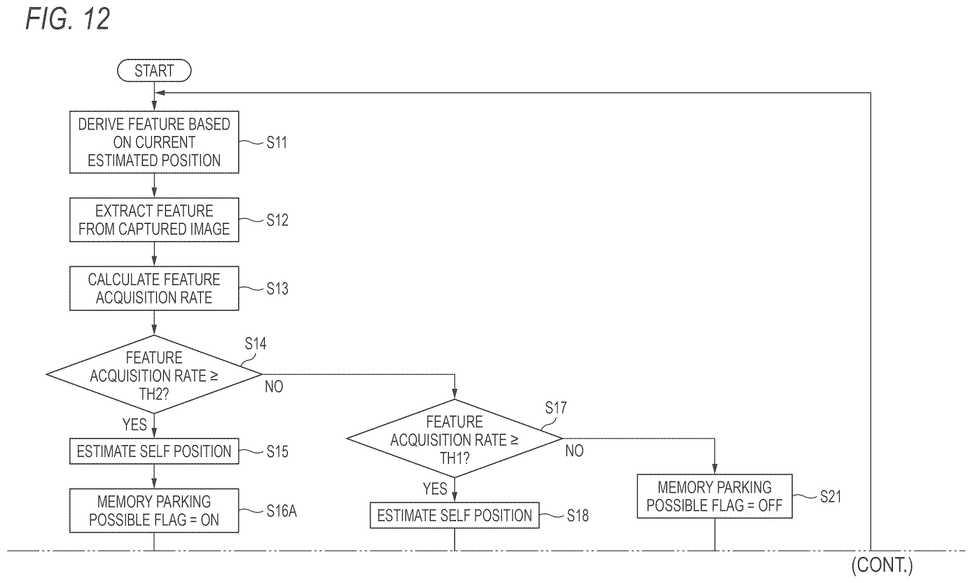

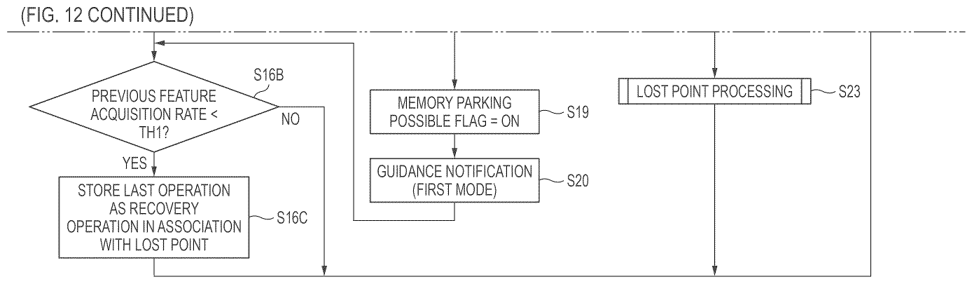

FIG. 12 is a flowchart illustrating a second example of the position estimation processing. As illustrated in FIG. 12, the processing from step S11 to step S16A is the same as the processing from step S11 to step S16 in the position estimation processing of the first example described with reference to FIG. 11.

In step S16A, after setting the memory parking possible flag to ON, which indicates that the current situation is one in which the memory parking can be executed, the vehicle 10 determines whether a previous feature acquisition rate was less than TH1 (for example, 30%) (step S16B). The previous feature acquisition rate is a feature acquisition rate calculated in step S13 of the previous processing in loop processing of FIG. 12. Note that in the first round of processing, since there is no previous feature acquisition rate, it is determined that the previous feature acquisition rate was not less than TH1.

If it is determined in step S16B that the previous feature acquisition rate was less than TH1 (step S16B: Yes), the vehicle 10 stores an operation performed most recently to improve the reliability as a recovery operation in the storage unit 54, in association with the point stored as a lost point in the previous processing (step S16C), and then returns to step S11. If it is determined in step S16B that the previous feature acquisition rate is not less than TH1 (step S16B: NO), the vehicle 10 returns to step S11.

The processing from step S17 to step S20 is the same as the processing from step S17 to step S20 in the position estimation processing of the first example described with reference to FIG. 11.

After issuing the guidance notification in the first mode in step S20, the vehicle 10 determines whether the previous feature acquisition rate was less than TH1 (step S16B). Note that the processing after the determination processing in step S16B is the same as described above.

The processing of step S21 is the same as the processing of step S21 in the position estimation processing of the first example described with reference to FIG. 11.

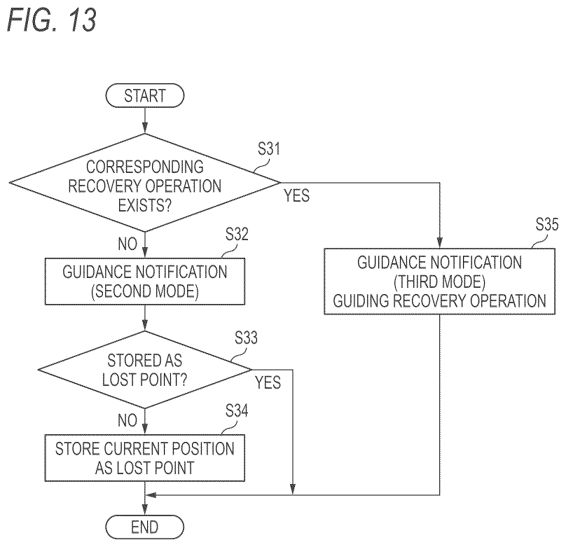

After setting the memory parking possible flag to OFF in step S21, the vehicle 10 performs lost point processing (step S23). The lost point processing will be described below with reference to FIG. 13.

### Lost Point Processing

FIG. 13 is a flowchart illustrating a first example of the lost point processing. The lost point processing is executed as the lost point processing in step S23 of FIG. 12. The lost point processing is processing that is executed when the vehicle 10 is at a point where the current position thereof cannot be estimated.

First, the vehicle 10 determines whether a lost point near the current estimated position is stored in the storage unit 54 and whether a recovery operation for improving the reliability of the estimated position is stored in association with the lost point (step S31).

In step S31, if the corresponding recovery operation is not stored (step S31: No), the vehicle 10 issues a guidance notification in a second mode to guide the user to perform a predetermined operation for improving the reliability of the estimated position (step S32).

Next, the vehicle 10 determines whether a vicinity of the current estimated position has already been stored as a lost point (step S33). In step S33, if the vicinity of the current estimated position has not been stored as a lost point (step S33: No), the vehicle 10 stores the current position in the storage unit 54 as a lost point (step S34), and then ends the processing. In step S33, if the vicinity of the current estimated position has been stored as a lost point (step S33: Yes), the vehicle 10 ends the processing.

On the other hand, if it is determined in step S31 that the corresponding recovery operation is stored (step S31: Yes), the vehicle 10 issues a guidance notification in a third mode that guides the user to perform the recovery operation (step S35), and then ends the processing.

Note that the recovery operation is stored for each lost point. The recovery operation may also be stored together with information on peripheral environment at the lost point. The information on the peripheral environment includes, for example, brightness and weather of the lost point.

In this way, the control device stores in the storage unit 54 the point where the reliability of the estimated position is less than the first predetermined value and the memory parking of the vehicle 10 is no longer performed, in association with the user operation that was able to increase the reliability at that point to be equal to or greater than the first predetermined value. With this configuration, even when the reliability decreases and the memory parking cannot be performed, a guidance notification of an effective user operation capable of improving the reliability and enabling the memory parking to be performed can be provided. In this way, the usability of the memory parking function of the vehicle 10 can be improved.

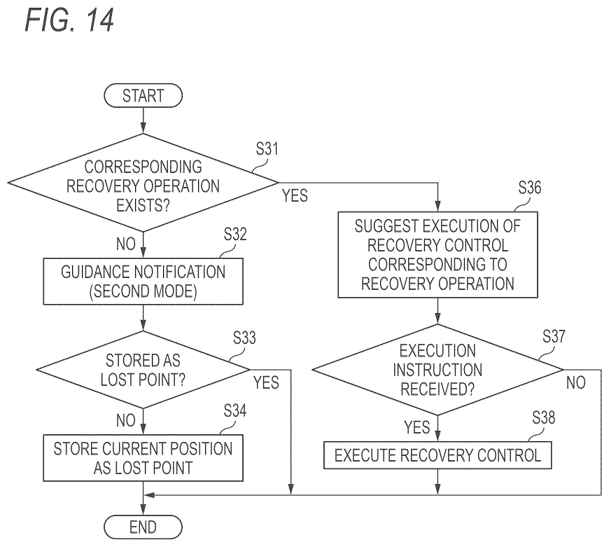

FIG. 14 is a flowchart illustrating a second example of the lost point processing. As illustrated in FIG. 14, the processing from step S31 to step S34 is the same as the processing from step S31 to step S34 in the lost point processing of the first example described with reference to FIG. 13.

In the second example, if it is determined in step S31 that a recovery operation corresponding to the lost point is stored (step S31: Yes), the vehicle 10 suggests to the user execution of recovery control corresponding to the recovery operation (step S36). The execution of the recovery control is execution by the movement control unit 57 of the vehicle 10.

The vehicle 10 determines whether an execution instruction has been received from the user in response to the suggestion made in step S36 (step S37). If an execution instruction has been received in step S37 (step S37: Yes), the vehicle 10 executes recovery control corresponding to the recovery operation (step S38) and then ends the processing. If an execution instruction has not been received in step S37 (step S37: No), the vehicle 10 ends the processing.

In this way, when the vehicle 10 arrives again at the point where the reliability of the position estimation is less than the first predetermined value and the memory parking cannot be performed, the control device performs control on the device side in response to the user operation that is associated with that point and can increase the reliability to be equal to or greater than the first predetermined value. With this configuration, even when the reliability is low and the memory parking can no longer be executed, the reliability can be increased by control on the device side and the memory parking can be resumed without waiting for any user operation. In this way, the usability of the memory parking function of the vehicle 10 can be improved.

The control method described in the above embodiment may be implemented by executing a control program prepared in advance on a computer. The control program is stored in a computer-readable storage medium and executed by being read from the storage medium. Further, the control program may be provided in a form stored in a non-transitory storage medium such as a flash memory, or may be provided via a network such as the Internet. The computer that executes the control program may be provided in the control device, may be provided in an electronic device such as a smartphone, a tablet terminal, or a personal computer that can communicate with the control device, or may be provided in a server device that can communicate with the control device and the electronic device.

Although the embodiment of the present disclosure has been described above, the present disclosure is not limited to the above-described embodiment, and modifications, improvements, and the like can be appropriately made.

In the above embodiment, the vehicle 10 is parked in the parking facility 60 using the memory parking, but the present disclosure is not limited thereto. For example, the present disclosure can be applied to memory parking of the vehicle 10 in a parking lot at home or in a parking section at a coin-operated parking lot. In addition, the present disclosure can be applied not only to the case where the vehicle 10 is subjected to the memory parking, but also to a case where the vehicle is subjected to the memory exiting, or the user is manually driving the vehicle in the parking facility 60, or the vehicle 10 is autonomously traveling on an ordinary road.

In the above embodiment, the vehicle is a four-wheeled automobile, but the vehicle is not limited thereto. For example, the vehicle may be a two-wheeled vehicle, a Segway, or the like. Further, the idea of the present disclosure is not limited to the vehicle, and may also be applied to a robot, a ship, an aircraft, or the like that includes a drive source and is movable by power of the drive source.

In the present specification, at least the following matters are described. In the parentheses, the corresponding constituent elements and the like in the above embodiment are shown, but the present disclosure is not limited thereto.

(1) A control device (control ECU 20) for a moving object, the control device including:
a storage (storage unit 54) that stores parking information indicating a movement start point (movement start point 61) of the moving object, a parking section (parking section 62) of the moving object, and a movement route (movement route 63) of the moving object from the movement start point to the parking section; and
processing circuitry (external environment recognition unit 55, position estimation unit 56, movement control unit 57, notification control unit 58) configured to
   acquire external environment information of the moving object,
      perform position estimation on the moving object based on a feature extracted from the external environment information and map information,
      perform movement control to move the moving object from the movement start point to the parking section based on a result of the position estimation and the parking information, and
      issue, according to reliability of the position estimation, a guidance notification to guide a user to perform an operation for improving the reliability of the position estimation.

According to (1), by issuing a guidance notification that guides the user to perform an operation for improving the reliability of the position estimation that estimates the position of the moving object according to the reliability, it is possible to improve the reliability of the position estimation and improve the usability of the movement control function of the moving object.

(2) The control device according to (1), in which
the processing circuitry is configured to
   perform the movement control when the reliability is equal to or greater than a first predetermined value, and
      issue the guidance notification when the reliability is less than a second predetermined value that is higher than the first predetermined value.

According to (2), by issuing a guidance notification when the reliability is less than the second predetermined value that is higher than the first predetermined value, it is possible to issue a guidance notification when the moving object is under movement control.

(3) The control device according to (2), in which
the processing circuitry is configured to issue, in response to the reliability being less than the first predetermined value, a guidance notification that is different from a guidance notification issued in response to the reliability being equal to or greater than the first predetermined value and less than the second predetermined value.

According to (3), the guidance notification differs between when the reliability is less than the first predetermined value and the moving object is not under movement control, and when the reliability is equal to or greater than the first predetermined value and less than the second predetermined value and the moving object is under movement control, and therefore, a guidance notification appropriate for the reliability can be provided.

(4) The control device according to any one of (1) to (3), in which
the processing circuitry is configured to
   display a peripheral image of the moving object based on the external environment information, and
      perform attention display of a partial area of the peripheral image according to the reliability.

According to (4), by performing attention display on the partial area in the peripheral image according to the reliability, a rate at which the user performs an operation in response to the guidance notification can be increased, and the usability of the movement control function of the moving object can be further improved.

(5) The control device according to (4), in which
the processing circuitry is configured to change a mode of the attention display according to the reliability.

As in (5), by changing the mode of the attention display depending on the reliability, the rate at which the user performs an operation in response to the guidance notification can be further increased.

(6) The control device according to any one of (1) to (5), in which
the processing circuitry is configured to
   perform the movement control in response to the reliability being equal to or greater than a first predetermined value, and,
      in response to the reliability being less than the first predetermined value, store in association with each other a point where the moving object is positioned at a time when the reliability becomes less than the first predetermined value and a user operation performed at a time when the reliability changes from being less than the first predetermined value to being equal to or greater than the first predetermined value at the point.

According to (6), by storing the point where the reliability is less than the first predetermined value and the movement control of the moving object cannot be performed in association with the user operation performed at that point and capable of increasing the reliability to be equal to or greater than the first predetermined value, an effective guidance notification can be provided, and the usability of the movement control function of the moving object can be further improved.

(7) The control device according to (6), in which
the processing circuitry is configured to issue a guidance notification to show the user the user operation associated with the stored point in response to the moving object arriving at the stored point again.

As in (7), when the moving object arrives again at the point where the reliability is less than the first predetermined value and the movement control cannot be performed, the usability of the movement control function of the moving object can be improved by issuing a guidance notification that guides a user operation in association with that point.

(8) The control device according to (6), in which
the processing circuitry is configured to perform control of the moving object corresponding to the user operation associated with the stored point in response to the moving object arriving at the stored point again.

As in (8), when the moving object arrives again at the point where the reliability is less than the first predetermined value and the movement control cannot be performed, the usability of the movement control function of the moving object can also be improved by the device side performing control corresponding to the user operation in association with that point.

(9) The control device according to any one of (1) to (8), in which
the operation for improving the reliability includes at least one of
   an operation for changing a movement speed of the moving object,
   an operation for changing a movement trajectory of the moving object, or
   an operation for controlling a lighting device of the moving object.

As in (9), the operation for improving the reliability preferably includes changes in the movement speed or movement trajectory of the moving object, control of a lighting device, and the like.

(10) A control method of a control device for a moving object, including:
acquiring external environment information of the moving object;
   storing parking information indicating a movement start point of the moving object, a parking section of the moving object, and a movement route of the moving object from the movement start point to the parking section;
   performing position estimation on the moving object based on a feature extracted from the external environment information and map information;
   performing movement control to move the moving object from the movement start point to the parking section based on a result of the position estimation and the parking information; and,
   according to reliability of the position estimation, issuing a guidance notification to guide a user to perform an operation for improving the reliability of the position estimation.

According to (10), by issuing a guidance notification that guides the user to perform an operation for improving the reliability of the position estimation that estimates the position of the moving object according to the reliability, it is possible to improve the reliability of the position estimation and improve the usability of the movement control function of the moving object.

(11) A non-transitory computer-readable storage medium storing a control program of a control device for a moving object, the control program causing a processor of the control device to execute a process including:
acquiring external environment information of the moving object;
storing parking information indicating a movement start point of the moving object, a parking section of the moving object, and a movement route of the moving object from the movement start point to the parking section;
performing position estimation on the moving object based on a feature extracted from the external environment information and map information:
performing movement control to move the moving object from the movement start point to the parking section based on a result of the position estimation and the parking information; and,
according to reliability of the position estimation, issuing a guidance notification to guide a user to perform an operation for improving the reliability of the position estimation.

According to (11), by issuing a guidance notification that guides the user to perform an operation for improving the reliability of the position estimation that estimates the position of the moving object according to the reliability, it is possible to improve the reliability of the position estimation and improve the usability of the movement control function of the moving object.

What is claimed is:

1. A control device for a moving object, the control device comprising:
a storage that stores parking information indicating a movement start point of the moving object, a parking section of the moving object, and a movement route of the moving object from the movement start point to the parking section; and
processing circuitry configured to
acquire external environment information of the moving object,
perform position estimation on the moving object based on a feature extracted from the external environment information and map information,
perform movement control to move the moving object from the movement start point to the parking section based on a result of the position estimation and the parking information, and
issue, according to reliability of the position estimation, a guidance notification to guide a user to perform an operation for improving the reliability of the position estimation.

2. The control device according to claim 1, wherein
the processing circuitry is configured to
perform the movement control when the reliability is equal to or greater than a first predetermined value, and
issue the guidance notification when the reliability is less than a second predetermined value that is higher than the first predetermined value.

3. The control device according to claim 2, wherein
the processing circuitry is configured to issue, in response to the reliability being less than the first predetermined value, a guidance notification that is different from a guidance notification issued in response to the reliability being equal to or greater than the first predetermined value and less than the second predetermined value.

4. The control device according to claim 1, wherein
the processing circuitry is configured to
display a peripheral image of the moving object based on the external environment information, and
perform attention display of a partial area of the peripheral image according to the reliability.

5. The control device according to claim 4, wherein
the processing circuitry is configured to change a mode of the attention display according to the reliability.

6. The control device according to claim 1, wherein
the processing circuitry is configured to
perform the movement control in response to the reliability being equal to or greater than a first predetermined value, and,
in response to the reliability being less than the first predetermined value, store in association with each other a point where the moving object is positioned at a time when the reliability becomes less than the first predetermined value and a user operation performed at a time when the reliability changes from being less than the first predetermined value to being equal to or greater than the first predetermined value at the point.

7. The control device according to claim 6, wherein
the processing circuitry is configured to issue a guidance notification to show the user the user operation associated with the stored point in response to the moving object arriving at the stored point again.

8. The control device according to claim 6, wherein
the processing circuitry is configured to perform control of the moving object corresponding to the user operation associated with the stored point in response to the moving object arriving at the stored point again.

9. The control device according to claim 1, wherein
the operation for improving the reliability includes at least one of
an operation for changing a movement speed of the moving object,
an operation for changing a movement trajectory of the moving object, or
an operation for controlling a lighting device of the moving object.

10. A control method of a control device for a moving object, comprising:
acquiring external environment information of the moving object;
storing parking information indicating a movement start point of the moving object, a parking section of the moving object, and a movement route of the moving object from the movement start point to the parking section;
performing position estimation on the moving object based on a feature extracted from the external environment information and map information;
performing movement control to move the moving object from the movement start point to the parking section based on a result of the position estimation and the parking information; and,
according to reliability of the position estimation, issuing a guidance notification to guide a user to perform an operation for improving the reliability of the position estimation.

11. A non-transitory computer-readable storage medium storing a control program of a control device for a moving object, the control program causing a processor of the control device to execute a process comprising:
acquiring external environment information of the moving object;
storing parking information indicating a movement start point of the moving object, a parking section of the moving object, and a movement route of the moving object from the movement start point to the parking section;
performing position estimation on the moving object based on a feature extracted from the external environment information and map information:
performing movement control to move the moving object from the movement start point to the parking section based on a result of the position estimation and the parking information; and,
according to reliability of the position estimation, issuing a guidance notification to guide a user to perform an operation for improving the reliability of the position estimation.
